(19) United States
(12) Patent Application Publication
(10) Pub. No.: US 2024/0349344 A1
(43) Pub. Date: Oct. 17, 2024

(54) METHOD AND NODE FOR TRANSMISSION ON UNLICENSED BAND

(71) Applicant: Telefonaktiebolaget LM Ericsson (publ), Stockholm (SE)

(72) Inventor: Min Wang, Luleå (SE)

(21) Appl. No.: 18/683,297

(22) PCT Filed: Aug. 10, 2022
(86) PCT No.: PCT/EP2022/072469

§ 371 Date: Feb. 13, 2024

(30) Foreign Application Priority Data
Sep. 10, 2021 (WO) PCT/EP2021/074923

(51) Int. Cl. H04W 74/0816; H04W 72/231; H04W 74/00; H04W 92/18

(52) U.S. Cl. CPC H04W 74/0816; H04W 72/231; H04W 74/002; H04W 92/18

(57) ABSTRACT

The embodiments herein relate to channel occupancy time sharing for sidelink transmission on unlicensed band. In some embodiments, there proposes a method performed by a first node, comprising: initiating a first transmission within an occupied channel occupancy time (COT) over an unlicensed band; and transmitting information regarding the COT to at least one second node, to enable the at least one second node to initiate a second transmission within the COT over the unlicensed band, wherein at least one of the first transmission or the second transmission is a sidelink transmission. With the embodiments herein, the frequency of LBT operation may be minimized, and the latency may be reduced due to fewer LBT operation. Therefore, channel utilization ratio may be improved due to that multiple UEs are allowed to share the channel, and the Quality of Service (QOS) satisfaction of services may also be improved.

### TECHNICAL FIELD

The embodiments herein relate generally to the field of wireless communication, and more particularly, the embodiments herein relate to method and node for transmission on unlicensed band.

### BACKGROUND

Next generation communication systems are expected to support a wide range of use cases with varying requirements ranging from fully mobile devices to stationary Internet of Things (IoT) or fixed wireless broadband devices. The traffic pattern associated with many use cases is expected to consist of short or long bursts of data traffic with varying length of waiting period in between (also called inactive state). For next 3rd Generation Partnership Project (3GPP) releases, sidelink transmission on unlicensed spectrum is a new technology which is attracting strong interest from companies.

In order to support sidelink transmission on unlicensed spectrum, a sidelink capable User Equipment (UE) may need to perform a Clear Channel Assessment (CCA). This procedure typically includes sensing the medium such as air interface to be idle for a number of time intervals. In case the channel is determined to be occupied, the transmitter performs a random back-off within a contention window before next CCA attempt. As a CCA technology, Listen-before-talk (LBT) is designed for unlicensed spectrum co-existence with other Radio Access Technologies (RATs). However, LBT operation will cause transmission latency for the sidelink transmission on unlicensed spectrum.

### SUMMARY

In view of the above problem, the embodiments herein propose methods, nodes, computer readable mediums and computer program products for channel occupancy time sharing for sidelink transmission on unlicensed band.

In some embodiments, there proposes a method performed by a first node (such as a sidelink capable UE or gNB). In an embodiment, the method may comprise the step of initiating a first transmission within an occupied channel occupancy time (COT) over an unlicensed band. Furthermore, the method may further comprise the step of transmitting information regarding the COT to at least one second node, to enable the at least one second node to initiate a second transmission within the COT over the unlicensed band. Here, at least one of the first transmission or the second transmission may be a sidelink transmission.

In an embodiment, the first node may be a first UE or a NodeB (such as gNB), the first transmission may be a sidelink transmission, the at least one second node may include a second UE or be a NodeB, and the second transmission may be a Uu transmission.

In an embodiment, the first node may be a first UE, the first transmission may be a Uu transmission, the at least one second node may include a second UE, and the second transmission may be a sidelink transmission.

In an embodiment, the first node may be a NodeB, the first transmission may be a Uu transmission, the at least one second node may include a second UE, and the second transmission may be a sidelink transmission.

In an embodiment, the first node may be a first UE or a NodeB, the first transmission may be a sidelink transmission for a first cast type, the at least one second node may include a second UE, and the second transmission may be a sidelink transmission for a second cast type. In an embodiment, the first or second cast type may be one of unicast, groupcast, or broadcast.

In an embodiment, the COT may be occupied by a schedule request (SR) procedure, a two-step random access (RA), or one or more sidelink transmissions using sidelink grants. In an embodiment, the COT may be occupied after a successful LBT operation. In an embodiment, the sidelink grant may be one of dynamic sidelink grant, configured sidelink grant, or sidelink grant obtained by the first node itself from a resource pool.

In an embodiment, the information regarding the COT may be transmitted over the sidelink and/or the Uu link. In an embodiment, the information regarding the COT may be transmitted from the NodeB to the second UE via at least one of a Downlink Control Information (DCI) based signaling, a medium access control (MAC) control element (CE) based signaling, a radio resource control (RRC) signaling, a control packet data unit (PDU) of a protocol layer based signaling. In another embodiment, the information regarding the COT may be transmitted from the first UE to the second UE via at least one of a RRC signaling on the sidelink, a MAC CE on the sidelink, a PDU of a protocol layer on the sidelink, a layer 1 (L1) signaling on the sidelink.

In an embodiment, the gap between the first transmission and the second transmission may be a value below 16 us or a value between 16 us and 25 us.

In an embodiment, information for COT sharing between the first node and the at least one second node may be obtained directly or indirectly from the information regarding the COT.

In an embodiment, the information regarding the COT may include at least one of: the time when the COT starts, the time when the COT ends, the time instants when a channel switch may occur, or the maximum number of channel switch events.

In an embodiment, the information regarding the COT may further include at least one of:
the UE ID, or Destination L2 ID which has occupied the COT;
the gNB IDs or cell IDs which are allowed to use/share the COT;
the UE IDs that are allowed to share/use the COT;
the group IDs that are allowed to share/use the COT for groupcast case;
the Destination L2 IDs which are allowed to share/use the COT;
the SL transmission cast types which are allowed within the COT;
indicators on whether the COT can be shared with Uu transmissions;
the indices of services/logical channels/logical channel groups/channel access priority classes that are allowed to transmit within the COT;
what type control signaling/data is allowed to transmit within the COT; or the category of LBT operations which is allowed for the at least second node to occupy the COT to be applied prior to its transmissions during the COT.

In an embodiment, the information regarding the COT further includes at least one of: the types of sidelink grants which are allowed to use during the COT; or the time positions reserved for potential discovery reference signal (DRS) transmissions.

In some embodiments, there proposes a method performed by a second node (such as a sidelink capable UE or gNB). In an embodiment, the method may comprise the step of receiving information regarding a COT from a first node, wherein the COT is occupied by the first node for initiating a first transmission over an unlicensed band. Furthermore, the method may further comprise the step of initiating a second transmission within the COT over the unlicensed band. Here, at least one of the first transmission or the second transmission may be a sidelink transmission.

In an embodiment, the method may further comprise the step of performing a LBT operation according to the COT information prior to initiating the second transmission. In another embodiment, the method may further comprise the step of performing a LBT operation according to the gap between the end of the first transmission and the beginning of the second transmission prior to initiating the second transmission. Here, the second transmission may be initiated after the LBT operation is successful.

In an embodiment, the method may further comprise the step of transmitting information regarding the COT to at least one third node, to enable the at least one third node to initiate a third transmission or reception within the COT over the unlicensed band. Here, at least one of the second transmission or the third transmission or reception may be a sidelink transmission or reception.

In an embodiment, the method may further comprise the step of increasing the frequency for physical downlink control channel (PDCCH) and/or sidelink control information (SCI) monitoring if the COT is assigned to the second node with the COT information. In another embodiment, the method may further comprise the step of decreasing the frequency for PDCCH and/or SCI monitoring if a COT is not assigned to the second node with the COT information.

In an embodiment, the method may further comprise the step of transmitting an acknowledgement message to the first node for indicating acceptance or rejection of joining the COT sharing.

In some embodiments, there proposes a node, which may be configured as the above first or second node. In an embodiment, the node may further comprise at least one processor; and a non-transitory computer readable medium coupled to the at least one processor. Here, the non-transitory computer readable medium may contain instructions executable by the at least one processor, whereby the at least one processor may be configured to perform any of the above methods related to the first or second node.

In some embodiments, there proposes a computer readable medium comprising computer readable code, which when run on an apparatus, causes the apparatus to perform any of the above methods related to the first or second node.

In some embodiments, there proposes a computer program product comprising computer readable code, which when run on an apparatus, causes the apparatus to perform any of the above methods related to the first or second node.

With the embodiments herein the frequency of LBT operation may be minimized, and the latency may be reduced due to fewer LBT operation.

Therefore, channel utilization ratio may be improved due to that multiple UEs are allowed to share the channel, and the Quality of Service (Qos) satisfaction of services may also be improved.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic diagram showing an example of COT sharing initiated by gNB;

FIG. 2 is a schematic diagram showing an example of COT sharing initiated by UE;

FIG. 3 is a schematic block diagram showing a communication system, in which the embodiments herein can be implemented;

FIG. 4 is a schematic signaling chart showing the messages in an example COT sharing for sidelink over unlicensed band, according to the embodiments herein;

FIG. 5 is a schematic signaling chart showing the messages in another example COT sharing for sidelink over unlicensed band, according to the embodiments herein;

FIG. 6 is a schematic flow chart showing an example method in the first node, according to the embodiments herein;

FIG. 7 is a schematic flow chart showing an example method in the second node, according to the embodiments herein;

FIG. 8 is a schematic block diagram showing an example first node, according to the embodiments herein;

FIG. 9 is a schematic block diagram showing an example second node, according to the embodiments herein;

FIG. 10 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “node” used herein means both wireless communication node or base node. For example, the node may be a user equipment or mobile station in any of the communication standard, such as 2G, 3G, 4G, 5G or beyond. For example, the node may be a base station, NodeB, eNB, or gNB in any of the communication standard, such as 2G, 3G, 4G, 5G or beyond.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

### NR based access to Unlicensed spectrum

In New Radio (NR), both license assisted access and standalone unlicensed operation are to be supported in 3GPP. Hence the procedure of Physical Random Access Channel (PRACH) transmission and/or SR transmission in unlicensed spectrum is investigated in 3GPP. In the following, NR-U and channel access procedure for an unlicensed channel based on LBT is introduced.

### NR-U introduction

In order to tackle with the ever increasing data demanding, NR is supported on both licensed and unlicensed spectrum (i.e., referred to as NR-U). Compared to the Long Term Evolution (LTE) Licensed-Assisted Access (LAA), NR-U supports DC (dual connectivity) and standalone scenarios, where the MAC procedures including Random Access Channel (RACH) and scheduling procedure on unlicensed spectrum are subject to the LBT failures, while there was no such restriction in LTE LAA, since there was licensed spectrum in LAA scenario so the RACH and scheduling related signaling can be transmitted on the licensed spectrum instead of unlicensed spectrum.

For DRS transmission such as Primiary Synchronization Signal (PSS)/Secondary Synchronization Signal (SSS), Physical Broadcast Channel (PBCH), Channel State Information-Reference Signal (CSI-RS), control channel transmission such as Physical Uplink Control Channel (PUCCI)/PDCCHI, physical data channel such as Physical Uplink Shared Channel (PUSCH)/Physical Downlink Shared Channel (PDSCH), and uplink sounding reference signal such as Sounding Reference Signal (SRS) transmission, channel sensing should be applied to determine the channel availability before the physical signal is transmitted using the channel.

The Radio Resource Management (RRM) procedures in NR-U would be generally rather similar as in LAA, since NR-U is aiming to reuse LAA/eLAA/feLAA technologies as much as possible to handle the coexistence between NR-U and other legacy RATs. RRM measurements and report comprising special configuration procedure with respect the channel sensing and channel availability.

Hence, channel access/selection for LAA was one of important aspects for co-existence with other RATs such as Wi-Fi. For instance, LAA has aimed to use carriers that are congested with Wi-Fi.

In licensed spectrum, UE measures Reference Signal Received Power (RSRP), and Reference Signal Received Quality (RSRQ) of the downlink radio channel (e.g. Synchronization Signal and PBCH block (SSB), CSI-RS), and provides the measurement reports to its serving eNB/gNB. However, they don't reflect the interference strength on the carrier. Another metric Received Signal Strength Indicator (RSSI) can serve for such purpose. At the eNB/gNB side, it is possible to derive RSSI based on the received RSRP and RSRQ reports, however, this requires that they must be available. Due to the LBT failure, some reports in terms of RSRP or RSRP may be blocked (can be either due to that the reference signal transmission (DRS) is blocked in the downlink or the measurement report is blocked in the uplink). Hence, the measurements in terms of RSSI are very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA has defined to support measurements of averaged RSSI and channel occupancy) for measurement reports. The channel occupancy is defined as percentage of time that RSSI was measured above a configured threshold. For this purpose, a RSSI measurement timing configuration (RMTC) includes a measurement duration (e.g. 1-5 ms) and a period between measurements (e.g. {40, 80, 160, 320, 640} ms).

### COT sharing in NR-U

For a node (e.g., NR-U gNB/UE, LTE-LAA eNB/UE, or Wi-Fi Access Point (AP)/Station (STA)) to be allowed to transmit in unlicensed spectrum (e.g., 5 GHz band) it typically needs to perform a CCA. This procedure typically includes sensing the medium to be idle for a number of time intervals. Sensing the medium to be idle can be done in different ways, e.g. using energy detection, preamble detection or using virtual carrier sensing. Where the latter implies that the node reads control information from other transmitting nodes informing when a transmission ends. After sensing the medium to be idle, the node is typically allowed to transmit for a certain amount of time, sometimes referred to as transmission opportunity (TXOP). The length of the TXOP depends on regulation and type of CCA that has been performed, but typically ranges from 1 ms to 10 ms. This duration is often referred to as a COT. In Wi-Fi, feedback of data reception acknowledgements (ACKs) is transmitted without performing clear channel assessment. Preceding feedback transmission, a small time duration (called Short Inter-Frame Space (SIFS)) is introduced between the data transmission and the corresponding feedback which does not include actual sensing of the channel. In IEEE 802.11, the SIFS period (16 us for 5 GHz Orthogonal Frequency Division Multiplexing (OFDM) Physicals (PHYs)) is defined as:

aSIFSTime=aRxPIIYDelay+aMACProcessingDelay+aRxTxTurnaroundTime, in which:
aRxPHYDelay defines the duration needed by the PHY layer to deliver a packet to the MAC layer;
aMACProcessingDelay defines the duration that the MAC layer needs to trigger the PHIY layer transmitting a response;
aRxTxTurnaroundTime defines the duration needed to turn the radio from reception into transmit mode.

Therefore, the SIFS duration is used to accommodate for the hardware delay to switch the direction from reception to transmission.

It is anticipated that for NR in unlicensed bands (NR-U), a similar gap to accommodate for the radio turnaround time will be allowed. For example, this will enable the transmission of PUCCH carrying Uplink

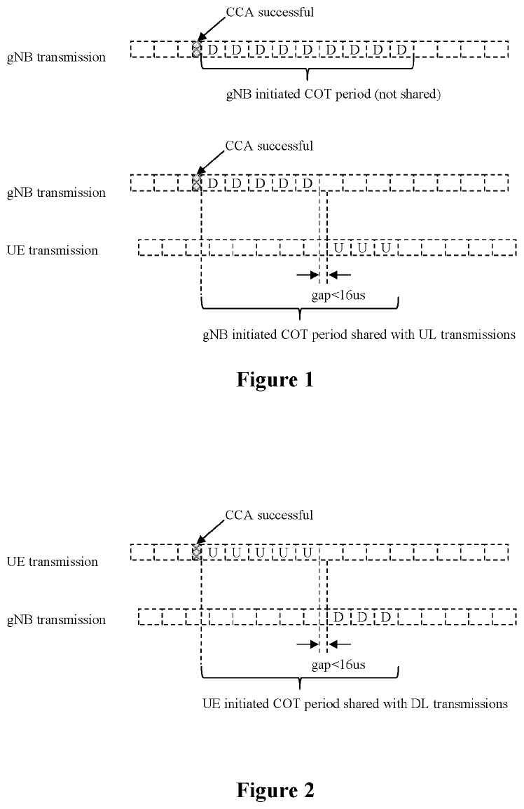

Control Information (UCI) feedback as well as PUSCH carrying data and possible UCI within the same TXOP acquired by the initiating gNB without the UE performing CCA before PUSCH/PUCCH transmission as long as the gap between downlink and uplink transmission is less than or equal to 16 us. Operation in this manner is typically called “COT sharing”. FIG. 1 is a schematic diagram showing an example of COT sharing initiated by gNB, which shows TXOP both with and without COT sharing where CCA is performed by the initiating node (gNB). For the case of COT sharing, the gap between downlink and uplink transmission is less than 16 us.

When UE accesses medium via Category-4 (Cat-4) LBT with a configured grant outside of a gNB COT, it is also possible for UE and gNB to share the UE acquired COT to schedule downlink data to the same UE. UE COT information can be indicated in UCI such as CG-UCI (configured grant-uplink control information) for configured grant PUSCH resources. FIG. 2 is a schematic diagram showing an example of COT sharing initiated by UE. For the case of COT sharing, the gap between uplink and downlink transmission is less than 16 us.

### Channel Access Procedure in NR-U

LBT is designed for unlicensed spectrum co-existence with other RATs. In this mechanism, a radio device applies a CCA check (i.e. channel sensing) before any transmission. The transmitter involves energy detection (ED) over a time period compared to a certain energy detection threshold (ED threshold) in order to determine if a channel is idle. In case the channel is determined to be occupied, the transmitter performs a random back-off within a contention window before next CCA attempt. In order to protect the ACK transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For QOS differentiation, a channel access priority based on the service type has been defined. For example, there are four LBT priority classes are defined for differentiation of channel access priorities between services using contention window size (CWS) and MCOT duration.

As described in 3GPP TR 38.889, the channel access schemes for NR-based access for unlicensed spectrum can be classified into the following categories:
Category 1: Immediate transmission after a short switching gap, i.e., no LBT
   This is used for a transmitter to immediately transmit after a uplink/downlink switching gap inside a COT.
   The switching gap from reception to transmission is to accommodate the transceiver turnaround time and is no longer than 16 us.
Category 2: LBT without random back-off
   The duration of time that the channel is sensed to be idle before the transmitting entity transmits is deterministic.
Category 3: LBT with random back-off with a contention window of fixed size
   The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.
Category 4: LBT with random back-off with a contention window of variable size
   The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

### SideLink Transmission in NR

Sidelink transmissions over NR are specified for 3GPP Release 16. These are enhancements of the ProSe (PROximity-based SErvices) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCHI) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of PSCCH.
To achieve a high connection density, congestion control and thus the QoS management is supported in NR sidelink transmissions.

To enable the above enhancements, new physical channels and reference signals are introduced in NR (available in LTE before):
PSSCH (Physical Sidelink Shared Channel, SL version of PDSCH):

The PSSCH is transmitted by a sidelink transmitter UE, which conveys sidelink transmission data, system information blocks (SIBs) for RRC configuration, and a part of the sidelink control information (SCI).
PSFCH (Physical Sidelink feedback channel): The PSFCH is transmitted by a sidelink receiver UE for unicast and groupcast, which conveys 1 bit information over 1 resource block for the Hybrid Automatic Repeat request (HARQ) acknowledgement (ACK) and the negative ACK (NACK). In addition, channel state information (CSI) is carried in the MAC CE over the PSSCH instead of the PSFCH.
PSCCH (Physical Sidelink Common Control Channel, sidelink version of PDCCH): When the traffic to be sent to a receiver UE arrives at a transmitter UE, a transmitter UE should first send the PSCCH, which conveys a part of SCI (Sidelink Control information, sidelink version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage sidelink control information (SCI). This is a version of the DCI for sidelink. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, NDI, RV and HARQ process ID is sent on the PSSCH to be decoded by the receiver UE.

Similar as for PROSE in LTE, NR sidelink transmissions have the following two modes of resource allocations:
Mode 1: Sidelink resources are scheduled by a gNB.
Mode 2: The UE autonomously selects sidelink resources from a (pre-) configured sidelink resource pool(s) based on the channel sensing mechanism.

For the in-coverage UE, a gNB can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a gNB (SR on uplink, grant, BSR (buffer status report) on uplink, grant for data on sidelink sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the DCI conveyed by PDCCH with Cyclic Redundancy Check (CRC) scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB (transport block). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB (transport block) decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE should select resources for the following transmissions:
1) The PSSCH associated with the PSCCH for initial transmission and blind retransmissions.
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs.

The sensing and selection algorithm is rather complex.

In order to support sidelink transmission on unlicensed spectrum (SL-U), similar channel access mechanism as in NR-U need to be introduced for SL-U. With channel access mechanism, a sidelink (SL) capable UE may need to perform LBT operation prior to a SL transmission. However, LBT operation will cause transmission latency for the SL transmission. In this case, the COT sharing mechanism similar as in NR-U would be beneficial to be also supported for SL-U.

However, the COT sharing mechanism in NR-U cannot be directly reused for SL-U. In NR-U, COT sharing enables a UE to share a uplink COT with the gNB (i.e., so called uplink COT sharing) or enables the gNB to share a downlink COT with one or multiple UEs (i.e., so called downlink COT sharing). In SL-U, COT sharing mechanism is able to enable a COT to be shared between SL UEs. Therefore, the COT sharing mechanism needs to be enhanced.

Mechanisms are proposed in the embodiments to enable a COT initiated by a SL UE or a gNB for SL transmissions to be shared with other UEs for SL transmissions. Similar mechanisms are also applicable to enable a COT initiated by a UE or a gNB for Uu transmissions to be shared with other UEs for SL transmissions.

Accordingly, the COT information associated with a shared COT needs to be signaled to other UEs. Different content has been proposed to be included in the COT information.

In addition, various signaling options are also proposed for the COT information.

The embodiments are described in the context of NR, i.e., two or more SL UEs are deployed in a same or different NR cell. However, the same principle may be applied to LTE or any other technology that enables the direct connection of two (or more) nearby devices. The embodiments are also applicable to relay scenarios including UE to network relay or UE to UE relay where the remote UE and the relay UE may be based on LTE sidelink or NR sidelink, the Uu connection between the relay UE and the base station may be LTE Uu or NR Uu.

The proposed mechanism is applicable to SL unlicensed operations (i.e., SL transmission on unlicensed band). The term LBT may also interchangeably called as clear channel assessment (CCA), shared spectrum access procedure etc. The carrier on which the LBT is applied may belong to a shared spectrum or an unlicensed band or band with contention based access etc. Below embodiments are not restricted by terms. Any similar term is equally applicable here.

The configurable LBT schemes comprise at least one of the below LBT categories, but not limited to the below examples;
Category 1: Immediate transmission after a short switching gap, i.e., no LBT
   This is used for a transmitter to immediately transmit after a UL/DL switching gap inside a COT.
   The switching gap from reception to transmission is to accommodate the transceiver turnaround time and is no longer than 16 us.
Category 2: LBT without random back-off
   The duration of time that the channel is sensed to be idle before the transmitting entity transmits is deterministic.
Category 3: LBT with random back-off with a contention window of fixed size
   The LBT procedure has the following procedure as one of its components. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.
Category 4: LBT with random back-off with a contention window of variable size
   The LBT procedure has the following as one of its components. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

The other LBT schemes such as directional LBT, omni-directional LBT, receiver assisted LBT are also applicable. The above similar LBT schemes may be also referred to as different terms (e.g., Type 1 or Type 2 channel access procedures in the 3GPP TS 37.213 V 16.6.0).

Note: in some unlicensed operation technologies (e.g., LTE unlicensed operation or NR unlicensed operation), when the gap from the end of a first transmission in one direction (e.g., from UE1 to UE2) to the beginning of a second subsequent transmission in the other direction (e.g., from UE2 to UE1) is not more than a fixed period (e.g., 16 us or 25 us), either Category 1 or Category 2 LBT can be chosen prior to the second transmission to avoid latency incurred by usage of Category 4 LBT operations. For SL transmissions, similar gap periods may be also introduced. However, the value of the gap period may be different from the ones used in these unlicensed operation technologies.

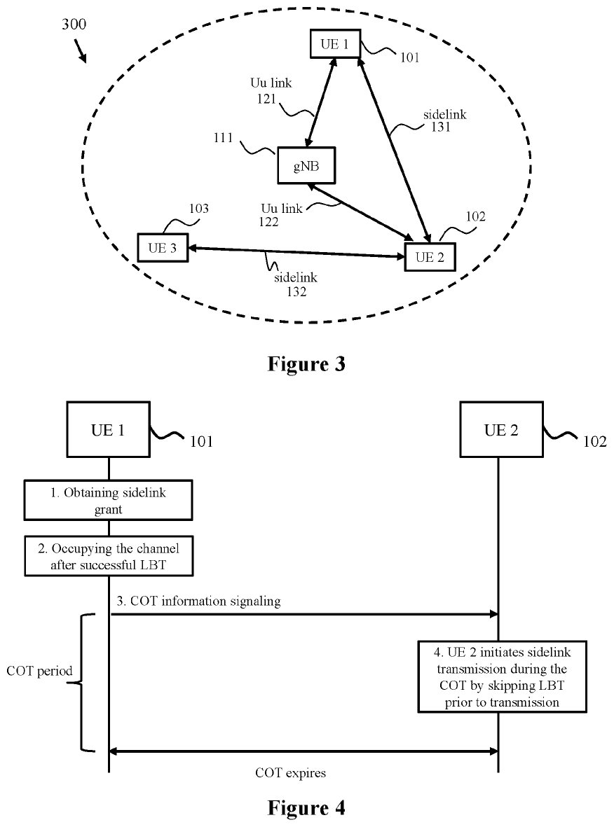

FIG. 3 is a schematic block diagram showing a communication system 300, in which the embodiments herein can be implemented.

In an embodiment, the communication system 300 may include a plurality of UEs (such as the UE 101, 102, and 103) and a base node (such as the gNB 111). The link over Uu interface (such as Uu link 121, 122) has been established between the UEs 101, 102 and the gNB 111, and sidelink (also called direct connection) (such as sidelink 131, 132) has been established between the UEs 101, 102 and 103.

In an embodiment, a methodology is proposed to enable a shared COT between multiple SL capable UEs. The COT is requested and thus occupied by the first UE 101 intended for SL transmission purpose. The COT may be obtained or occupied by the first UE 101 after LBT operation has succeeded. The COT information is signaled by the first UE 101 to the neighbor SL UEs (such as the UEs 102, 103). Within this shared COT, after a SL transmission by the first UE 101 to one or multiple neighbor UEs 102, 103 of the first UE 101, another SL transmission initiated by a second UE 102 to one or multiple neighbor UEs (such as the UE 103) of the second UE 102 is allowed to occupy the channel without performing LBT operation.

In this way, the COT is shared between the first UE 101 and the second UE 102. In other words, a channel occupancy switch occurs between the first UE 101 and the second UE 102. After one or multiple SL transmissions performed by the second UE 102 within the shared COT, the COT may be further shared with a third UE 103, a fourth UE for SL transmission or reception and so forth.

FIG. 4 is a schematic signaling chart showing the messages in an example COT sharing for sidelink over unlicensed band, according to the embodiments herein.

In this schematic signaling chart, the COT is shared between the first UE 101 and the second UE 102. In an embodiment, the COT sharing procedure may include the following messages or steps:
1. the first UE 101 may obtain a sidelink grant from the gNB 111.
2. the first UE 101 may perform a LBT procedure, and occupy the channel after successful LBT. Then, the first UE 101 may initiate a transmission (such as a sidelink transmission) by using the occupied COT.
3. the first UE 101 may transmit the COT information to the second UE 102 for COT sharing.
4. the second UE 102 may initiate sidelink transmission during the COT by skipping LBT prior to transmission.

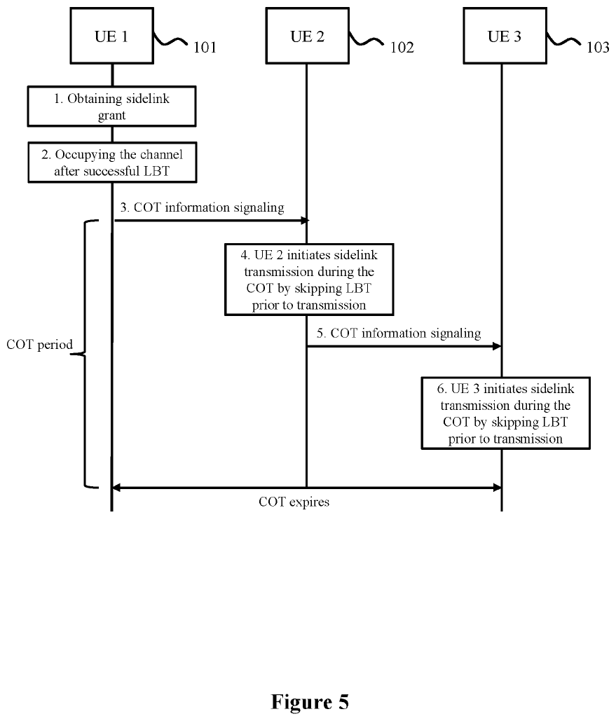

FIG. 5 is a schematic signaling chart showing the messages in another example COT sharing for sidelink over unlicensed band, according to the embodiments herein.

In this schematic signaling chart, the COT is shared between the first UE 101 and the second and third UEs 102, 103. In an embodiment, the COT sharing procedure may include the following messages or steps:
1. the first UE 101 may obtain a sidelink grant from the gNB 111.
2. the first UE 101 may perform a LBT procedure, and occupy the channel after successful LBT. Then, the first UE 101 may initiate a transmission (such as a sidelink transmission) by using the occupied COT.
3. the first UE 101 may transmit the COT information to the second UE 102 for COT sharing.
4. the second UE 102 may initiate sidelink transmission during the COT by skipping LBT prior to transmission.
5. the second UE 102 may transmit the COT information to a further third UE 103 for COT sharing.
6. the third UE 102 may initiate sidelink transmission during the COT by skipping LBT prior to transmission.

In an embodiment, the COT may be further shared with other UEs for Uu transmission or reception. For example, the UE 103 may use this COT for Uu transmission or reception with the gNB 111.

In an embodiment, the COT may be shared with gNB for Uu transmission or reception. For example, the gNB 111 may use this COT for Uu transmission or reception with any of the UEs.

In an embodiment, the signaling concerning the COT structure may contain/indicate at least one of the below information in a first set of information as a baseline, such as:
The time when the COT starts;
The time when the COT ends;
The time instants when a channel switch may occur;
The maximum number of channel switch events.

In addition, other information may be also included in a second set of information, such as:
The UE ID, or Destination L2 ID which has initiated the COT;
The gNB IDs or cell IDs which are allowed to use/share the COT;
The UE IDs that are allowed to share/use the COT;
The group IDs that are allowed to share/use the COT for groupcast case;
The Destination L2 IDs which are allowed to share/use the COT;
The SL transmission cast types (i.e., unicast, groupcast or broadcast) which are allowed within the COT;
Indicators on whether the COT can be shared with Uu transmissions;
The indices of services/logical channels/logical channel groups/channel access priority classes that are allowed to transmit within the COT;
What type control signaling/data is allowed to transmit within the COT;
The category of LBT operation which is allowed for the other node to occupy the COT prior to its transmissions, e.g.,
   In an example, a node (UE or gNB) can skip LBT (i.e., category 1 LBT) prior to its transmissions;
   In an example, a node (UE or gNB) need to perform category 2 LBT prior to its transmissions;
   In an example, a node (UE or gNB) needs to perform category 3 or category 4 LBT prior to its transmissions;
In case the COT is shared to the other nodes (UE or gNB)), whether CP (cyclic prefix) extension is enabled and how CP extension is performed by the other nodes prior to their transmissions when occupying the COT:
The types of SL grants which are allowed to use during the COT, i.e., dynamic grant, configured grant or grant obtained using Mode 2 resource allocation;
Time positions reserved for potential DRS transmissions.

In this way, the UEs 101, 102, 103 sharing the same COT may avoid the LBT operations or at least reduce the frequency of the LBT operations. Both latency and spectrum utilization efficiency may be improved.

In an embodiment, the COT information may not contain any UE ID, or any destination L2 IDs, or group IDs, in this case, the COT is open to any UE in the proximity. Any UE which can receive the COT information is allowed to access the channel without performing LBT operation.

In an embodiment, referring to the above step 1 of FIGS. 4 and 5, a COT is requested and obtained by a SL capable UE (such as the UE 101) via at least one of below alternatives.

Alternative 1: transmission of a PUCCH-SR and/or a SL BSR to the gNB for requesting SL resources for the UE. In this option, the UE has Uu connection to the gNB. The gNB can assign a COT for one or multiple UEs. In this alternative, the gNB can assign a shared COT for relevant UEs immediately upon reception of an SR. In the existing specifications, a trigger of a PUCCH-SR only indicates availability of the new data for an LCH. It means that some necessary enhancements regarding PUCCH-SR are needed in order to indicate the buffer status. In one example, a UE can be assigned with multiple PUCCH-SR resources (in frequency or time domain) for a LCH, each SR resource is associated with a specific buffer level. The UE triggers a corresponding SR based on the buffer level of the new data. In another example, single-bit PUCCH SR is extended to multiple-bits SR. then, more information can be carried with a multiple-bits SR.

Alternative 2: transmission of a 2-Step RA to the gNB for requesting SL resources for the UE. In the MsgA, a buffer status and/or a PHR can be carried in the payload. In this alternative, a 2-step RA is triggered instead of a PUCCH-SR due to arrival of new data or arrival of higher priority data, since a 2-step RA is able to carry a BSR or a PHR in the payload. Alternatively, transmission of a 4-step RA to the gNB for requesting SL resources for the UE may be applied.

Alternative 3: transmission of an SR plus subsequent BSRs to the gNB for requesting SL resources for the UE. This is one ordinary alternative. The UE first transmits an SR indicating presence of SL data for transmission. The gNB replies with a grant so that the UE can provide more detailed buffer status by including a BSR in the subsequent data transmission.

Alternative 4: uplink control information (UCI) provided to the gNB by the UE is extended to carry priority indicators and/or buffer status for a UE. The UCI contains at least one of the following content or signaling:
HARQ ACK/NAK;
Scheduling Request (SR);
CSI.

The UCI may be carried on PUCCH or PUSCH.

With Alternative 1 and Alternative 2, the UE may no need to transmit BSRs in subsequent data transmission after the first transmission of the SR or RA in order for the gNB to assign a COT to the UE, which may be shared with other UEs. With alternative 3, the gNB may need to base on both a SR and a subsequent BSR to learn the current full buffer status for a UE. For all alternatives, the gNB can estimate for how long time period a COT can be shared between UEs. Within this shared COT, these UEs can manage to empty their buffers given their sidelink radio link quality and power headroom. The UEs who are assigned to a COT are scheduled based on an improved scheduling strategy, such that the scheduling decision for UEs in a COT may be valid for the whole COT period. In other words, the other UEs which are not allowed to share this COT will not be scheduled during this COT period. While in an ordinary scheduling procedure, a scheduling decision for a UE is typically valid for just one scheduling period/TTI/slot.

Alternative 5: the COT is initiated by the UE by initiating one or multiple SL transmissions using SL configured grant.

For any one of the above alternatives, the COT is used by the UE to perform SL transmissions using SL grants which are obtained via Mode 1 resource allocation.

Alternative 6: the COT is initiated by the UE by initiating one or multiple SL transmissions using SL grants which are obtained by UE itself from a resource pool, i.e., also referred to as Mode 2 resource allocation.

In an embodiment, referring to the above step 4 and step 6 of FIGS. 4 and 5, in case one or several UEs have received a signaling indicating that a COT is assigned to them, the UEs would then switch from an infrequent PDCCH and/or SCI monitoring pattern to a more frequent PDCCH and/or SCI monitoring pattern. Whenever each of these UEs obtain a grant (via Mode 1 resource allocation or Mode 2 resource allocation) within the indicated shared COT period, the UE builds a MAC PDU and triggers a transmission accordingly. Within the shared COT period, the UEs joining the shared COT period schedule/organize transmissions considering below aspects.
1) Allow multiple UEs to use the medium/channel at the same time period (e.g., they may use different frequency resources) in this case, the resource utilization is improved. Also, avoid a single UE to fully occupy the channel, and block other UEs to access the channel.
   a. Alternatively, a single UE may be allowed to exclusively occupy the channel for faster transmission or reception.
   b. Whether allowing a single UE to exclusive occupy the channel or multiple UEs to share the channel may be configured by the gNB or preconfigured in the spec.
2) gap between any two consecutive transmissions is less than a configured time period (e.g., 16 us or 25 us. The gap may be a different value from 16 us or 25 us for SL transmissions e.g., a value below 16 us or a value between 16 us and 25 us). In this way, either Category 1 or Category 2 LBT can be chosen to avoid latency incurred by usage of Category 4 LBT operations.

In an embodiment, referring to the above step 3 and step 5 of FIGS. 4 and 5, for UEs that are not assigned with a COT, they can wait to access the channel after the current on-going COT (which is shared by other UEs) have expired, these UEs can switch to an infrequent PDCCH and/or SCI monitoring pattern until the current COT period has expired for power saving purpose. After expiration of the current on-going COT, these UEs can switch to a more frequent PDCCH and/or SCI monitoring pattern to prepare for reception of DL signaling or SCI signaling. After a while, if there is a COT assigned however not intended to them again, the UEs can switch back to an infrequent PDCCH and/or SCI monitoring pattern again, however if there is a COT assigned to a UE, the UE then switches to a frequent PDCCH and/or SCI monitoring pattern.

Note that, the above embodiments are not limited to share COT among the UEs, they may be also applicable to enable a COT to be shared between SL capable UEs (i.e., UEs are allowed to use the COT to perform SL transmission or reception) and/or between SL capable UEs and the gNB (i.e., the COT is allowed to be used by UEs and the gNB for transmission or reception in the Uu interface). To enable the COT to be shared between SL UEs and between SL UEs and the gNB, the COT information needs to be distributed or signaled in the SL links and the Uu links. If a COT is to be shared with the gNB, the COT information may therefore contain the corresponding gNB IDs or the cell IDs which are allowed to use the COT.

In an example, a COT is started by a SL UE or the gNB initially for SL transmissions, the COT can be shared with other UEs and gNBs for Uu transmissions.

In an example, a COT is started by a UE initially for Uu transmissions, the COT may be shared with other UEs for SL transmissions.

In an example, a COT is started by a gNB for Uu transmissions, the COT may be shared with other UEs for SL transmissions.

In an example, a COT is started by a SL UE or the gNB initially for SL transmissions of a specific cast type (e.g., unicast), the COT can be shared with other UEs for SL transmissions of a different cast type (e.g., groupcast or broadcast).

The COT information may be signaled or distributed in the SL links and/or the Uu links. A UE or the gNB which has received the COT information for a COT, the UE or the gNB can forward the COT information to other UEs or gNBs using SL signaling alternatives or Uu signaling alternatives.

In an embodiment, referring to the above step 3 and step 5 of FIGS. 4 and 5, the COT information is signaled to UEs by the gNB via at least one of the following signaling options:
1) A DCI based signaling option: the DCI may be in a group common PDCCH format. In one option, UEs which are allowed to share the COT are explicitly signaled in the DCI. In another option, UEs which are allowed to share the COT are inexplicitly signaled in the DCI. For instance, the DCI is addressed to or scrambled with specific IDs, which indicating the UEs which are allowed to share the COT.
2) A MAC CE based signaling option: a new MAC CE may be defined accordingly
3) An RRC signaling message: a new RRC signaling message may be introduced accordingly.
4) A control PDU of a protocol layer (e.g., SDAP, PDCP, or RLC) based signaling option.

The COT information is signaled in the cell/carrier/BWP/channel/sub-band, so that all UEs can read the signaling on whether there is a COT is scheduled in the cell/carrier/BWP/channel/sub-band. For each UE, there may be two options for the gNB to signal the UE on whether the UE is assigned to a COT.
Option 1: the UE IDs assigned to the COT are carried by the COT information signaling
Option 2: a UE may determine if it is assigned to the COT via a second signaling. The second signaling may be a dedicated DCI. In this option, a UE first detects if there is a COT assigned by the gNB via the COT information. After that, the UE can further decide if the COT is assigned to it via the reception of a second signaling. There may be multiple second signaling messages for a UE during a COT period. Each signaling message may indicate a new grant.
Option 3: a UE may determine if it is assigned to the COT via inexplicit fashion. In an example, the signaling is addressed to a specific sequence or a specific ID which is associated with the UE. Upon detection of the signaling addressed to the specific sequence the a specific ID which is associated with the UE, the UE can determine that the COT is assigned to it.

In an embodiment, referring to the above step 3 and step 5 of FIGS. 4 and 5, the COT information is signaled by a UE to other UEs via at least one of the following signaling options:
1) An RRC signaling on the SL;
2) A MAC CE on the SL;
3) A control PDU of a protocol layer on the SL (e.g., SDAP, PDCP, RLC, or an adaptation layer in case of SL relay);
4) A L1 signaling on the SL (e.g., the signaling may be carried on PSSCH, PSCCH, PSFCH etc).

In case the COT information of a COT is signalled in the SL links, the COT information may be transmitted in any cast type (i.e., unicast, groupcast or broadcast), which may be different from the cast type of the SL transmissions which are allowed to use/occupy the channel during the COT.

In case a UE has received the COT information of a COT, the UE may provide acknowledgement message to the UE or the gNB who has initiated the COT. In the acknowledgement message, the UE may indicate if the UE has agreed or disagreed to join the COT sharing. After reception of one or multiple acknowledgement message, the UE or the gNB may update the COT info and signal the updated COT info to UEs.

Similarly, if a gNB has received the COT information of a COT, the gNB may provide acknowledgement message to the UE or the gNB who has initiated the COT.

In addition, a signalling message may carry the COT info for one or multiple COTs. In this case, the same COT information is applicable or valid to multiple COTs. In this way, the signalling overhead introduced by the COT information can be minimized.

In an embodiment, referring to the above FIGS. 4 and 5, upon reception of a COT information signalling transmitted by a UE or a gNB, another UE may send an acknowledgement message to the UE or the gNB indicating acceptance or rejection to join the COT sharing.

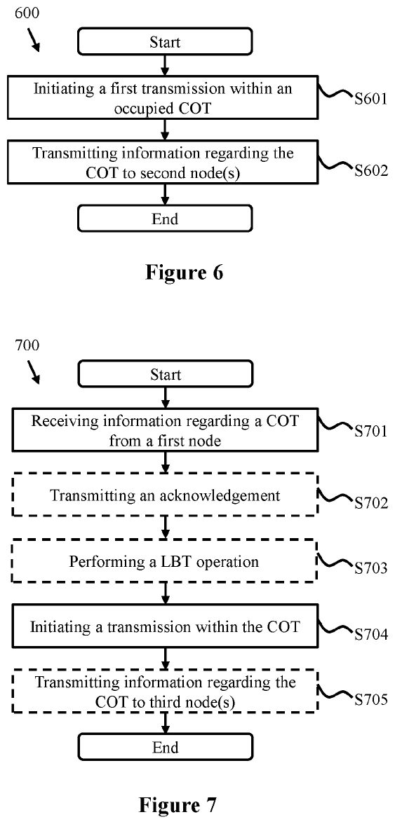

FIG. 6 is a schematic flow chart showing an example method 600 in the first node, according to the embodiments herein. In an embodiment, the flow chart in FIG. 6 may be implemented in the first node (such as the UE 101) in FIGS. 3-5.

The method 600 may begin with step S601, in which the first node may initiate a first transmission within an occupied COT over an unlicensed band.

In an embodiment, the COT may be occupied by a SR procedure, a two-step RA, or one or more sidelink transmissions using sidelink grants. In an embodiment, the COT may be occupied after a successful LBT operation. In an embodiment, the sidelink grant may be one of dynamic sidelink grant, configured sidelink grant, or sidelink grant obtained by the first node itself from a resource pool.

Then, the method 600 may proceed to step S602, in which the first node may transmit information regarding the COT to at least one second node, to enable the at least one second node to initiate a second transmission within the COT over the unlicensed band. Here, at least one of the first transmission or the second transmission may be a sidelink transmission.

In an embodiment, information for COT sharing between the first node and the at least one second node may be obtained directly or indirectly from the information regarding the COT.

In an embodiment, the information regarding the COT may be transmitted over the sidelink and/or the Uu link. In an embodiment, the information regarding the COT may be transmitted from the NodeB to the second UE via at least one of a DCI based signaling, a MAC CE based signaling, a RRC signaling, a control PDU of a protocol layer based signaling. In another embodiment, the information regarding the COT may be transmitted from the first UE to the second UE via at least one of a RRC signaling on the sidelink, a MAC CE on the sidelink, a PDU of a protocol layer on the sidelink, a L1 signaling on the sidelink.

In an embodiment, the information regarding the COT may include at least one of: the time when the COT starts, the time when the COT ends, the time instants when a channel switch may occur, or the maximum number of channel switch events.

In an embodiment, the information regarding the COT may further include at least one of:
the UE ID, or Destination L2 ID which has occupied the COT;
the gNB IDs or cell IDs which are allowed to use/share the COT;
the UE IDs that are allowed to share/use the COT;
the group IDs that are allowed to share/use the COT for groupcast case;
the Destination L2 IDs which are allowed to share/use the COT;
the SL transmission cast types which are allowed within the COT;
indicators on whether the COT can be shared with Uu transmissions;
the indices of services/logical channels/logical channel groups/channel access priority classes that are allowed to transmit within the COT;
what type control signaling/data is allowed to transmit within the COT; or
the category of LBT operations which is allowed for the at least second node to occupy the COT to be applied prior to its transmissions during the COT.

In an embodiment, the information regarding the COT further includes at least one of: the types of sidelink grants which are allowed to use during the COT; or the time positions reserved for potential DRS transmissions.

In an embodiment, the first node may be a first UE or a NodeB (such as gNB), the first transmission may be a sidelink transmission, the at least one second node may include a second UE or be a NodeB, and the second transmission may be a Uu transmission.

In an embodiment, the first node may be a first UE, the first transmission may be a Uu transmission, the at least one second node may include a second UE, and the second transmission may be a sidelink transmission.

In an embodiment, the first node may be a NodeB, the first transmission may be a Uu transmission, the at least one second node may include a second UE, and the second transmission may be a sidelink transmission.

In an embodiment, the first node may be a first UE or a NodeB, the first transmission may be a sidelink transmission for a first cast type, the at least one second node may include a second UE, and the second transmission may be a sidelink transmission for a second cast type. In an embodiment, the first or second cast type may be one of unicast, groupcast, or broadcast.

In an embodiment, the gap between the first transmission and the second transmission may be a value below 16 us or a value between 16 us and 25 us.

Then, the method 600 may proceed to step S602, in which the first node may receive a notification message comprising information indicating the PDN connectivity status from the second network function.

The above steps are only examples, and the first node may perform any actions described with respect to FIGS. 3-5, to monitor a PDN connectivity status of UE via the PDN connectivity status subscription procedure.

FIG. 7 is a schematic flow chart showing an example method 700 in the second node, according to the embodiments herein. In an embodiment, the flow chart in FIG. 7 may be implemented in the second node (such as the UE 102) in FIGS. 3-5.

The method 700 may begin with step S701, in which the second node may receive information regarding a COT from a first node, wherein the COT is occupied by the first node for initiating a first transmission over an unlicensed band.

In an embodiment, the method may further comprise the step of increasing the frequency for PDCCH and/or SCI monitoring if the COT is assigned to the second node with the COT information. In another embodiment, the method may further comprise the step of decreasing the frequency for PDCCH and/or SCI monitoring if a COT is not assigned to the second node with the COT information.

Then, the method 700 may proceed to step S702, in which the second node may transmit an optional acknowledgement message to the first node for indicating acceptance or rejection of joining the COT sharing.

Then, the method 700 may proceed to step S703, in which the second node may perform an optional LBT operation according to the COT information or the gap between the end of the first transmission and the beginning of the transmission of the second node. For example, the second node may perform LBT prior to its transmissions, in cases:
1) If the COT information indicates so; or
2) if the gap between the first transmission and the transmission of the second node larger than a gap period.

Then, the method 700 may proceed to step S704, in which the second node may initiate a second transmission within the COT over the unlicensed band. Note that, the transmission of the second node may be initiated after the optional LBT operation is successful. Here, at least one of the first transmission or the second transmission may be a sidelink transmission.

Then, the method 700 may proceed to step S704, in which the second node may optionally transmit information regarding the COT to at least one third node, to enable the at least one third node to initiate a third transmission or reception within the COT over the unlicensed band. Here, at least one of the second transmission or the third transmission or reception may be a sidelink transmission or reception.

The above steps are only examples, and the second node may perform any actions described with respect to FIGS. 3-5, to monitor a PDN connectivity status of UE via the PDN connectivity status subscription procedure.

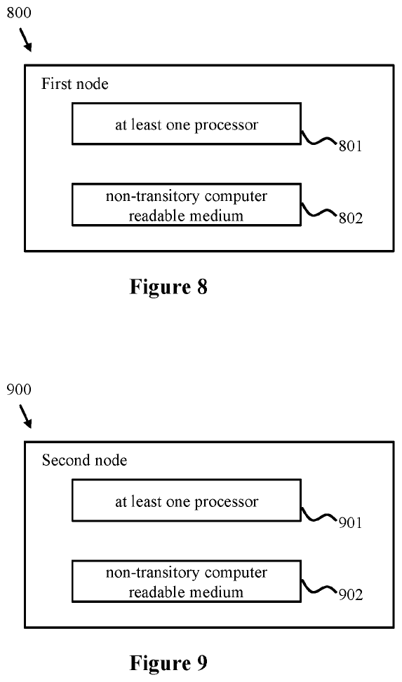

FIG. 8 is a schematic block diagram showing an example first node (such as the UE 101), according to the embodiments herein.

In an embodiment, the first node 800 may include at least one processor 801; and a non-transitory computer readable medium 802 coupled to the at least one processor 801. The non-transitory computer readable medium 802 contains instructions executable by the at least one processor 801, whereby the at least one processor 801 is configured to perform the steps in the example method 600 as shown in the schematic flow chart of FIG. 6; the details thereof are omitted here.

Note that, the first node 800 may be implemented as hardware, software, firmware and any combination thereof. For example, the first node 800 may include a plurality of units, circuities, modules or the like, each of which may be used to perform one or more steps of the example method 600 or one or more steps shown in FIGS. 3-5 related to the first node (such as the UE 101).

It should be understood that, the first node may be implemented either as a network element on a dedicated hardware, as a software instance running on a dedicated hardware, or as a virtualized function instantiated on an appropriate platform, e.g. on a cloud infrastructure.

FIG. 9 is a schematic block diagram showing an example second node (such as the UE 102), according to the embodiments herein.

In an embodiment, the second node 900 may include at least one processor 901; and a non-transitory computer readable medium 902 coupled to the at least one processor 901. The non-transitory computer readable medium 902 contains instructions executable by the at least one processor 901, whereby the at least one processor 901 is configured to perform the steps in the example method 700 as shown in the schematic flow chart of FIG. 7; the details thereof are omitted here.

Note that, the second node 900 may be implemented as hardware, software, firmware and any combination thereof. For example, the second node 900 may include a plurality of units, circuities, modules or the like, each of which may be used to perform one or more steps of the example method 700 or one or more steps shown in FIGS. 3-5 related to the second node (such as the UE 102).

It should be understood that, the second node may be implemented either as a network element on a dedicated hardware, as a software instance running on a dedicated hardware, or as a virtualized function instantiated on an appropriate platform, e.g. on a cloud infrastructure.

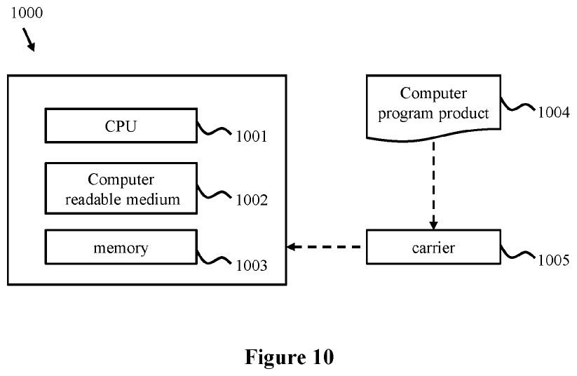

FIG. 10 is a schematic block diagram showing an example computer-implemented apparatus 1000, according to the embodiments herein. In an embodiment, the apparatus 1000 may be configured as the above mentioned apparatus, such as the first node (such as the UE 101) or the second node (such as the UE 102).

In an embodiment, the apparatus 1000 may include but not limited to at least one processor such as Central Processing Unit (CPU) 1001, a computer-readable medium 1002, and a memory 1003. The memory 1003 may comprise a volatile (e.g., Random Access Memory, RAM) and/or non-volatile memory (e.g., a hard disk or flash memory). In an embodiment, the computer-readable medium 1002 may be configured to store a computer program and/or instructions, which, when executed by the processor 1001, causes the processor 1001 to carry out any of the above mentioned methods.

In an embodiment, the computer-readable medium 1002 (such as non-transitory computer readable medium) may be stored in the memory 1003. In another embodiment, the computer program may be stored in a remote location for example computer program product 1004 (also may be embodied as computer-readable medium), and accessible by the processor 1001 via for example carrier 1005.

The computer-readable medium 1002 and/or the computer program product 1004 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25,

Internet, Local Area Network (LAN), or similar networks capable of transporting data packets to the infrastructure node).

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the following examples of embodiments and their equivalents, and shall not be restricted or limited by the foregoing detailed description.

Abbreviations
3GPP 3rd Generation Partnership Project
2G the 2nd Generation Mobile Communication Technology
3G the 3rd Generation Mobile Communication Technology
4G the 4th Generation Mobile Communication Technology
5G the 5th Generation Mobile Communication Technology
CCA Clear Channel Assessment
CE Control Element
COT Channel Occupancy Time
DCI Downlink Control Information
DRS Discovery Reference Signal
IoT Internet of Things
LAA Licensed Assisted Access
LBT Listen Before Talk
LTE Long Term Evolution
MAC Medium Access Control
NR New Radio
PDU Packet Data Unit
PDCCH Physical Downlink Control Channel
Qos Quality of Service
RA Random Access
RACH Random Access Channel
RAT Radio Access Technology
RRC Radio Resource Control
SCI Sidelink Control Information
SL sidelink
SR Schedule Request
TXOP transmission opportunity
UE User Equipment.

1. A method performed by a first node, comprising:
initiating a first transmission within an occupied channel occupancy time over an unlicensed band; and
transmitting information regarding the COT to at least one second node, to enable the at least one second node to initiate a second transmission within the COT over the unlicensed band,
wherein at least one of the first transmission or the second transmission is a sidelink transmission.

2. The method according to claim 1, wherein the first node is a first User Equipment (UE) or a NodeB,
wherein the first transmission is a sidelink transmission,
wherein the at least one second node includes a second UE or is a NodeB, and
wherein the second transmission is a Uu transmission.

3. The method according to claim 1, wherein the first node is a first User Equipment (UE),
wherein the first transmission is a Uu transmission,
wherein the at least one second node includes a second UE, and
wherein the second transmission is a sidelink transmission.

4. The method according to claim 1, wherein the first node is a NodeB,
wherein the first transmission is a Uu transmission,
wherein the at least one second node includes a second UE, and
wherein the second transmission is a sidelink transmission.

5. The method according to claim 1, wherein the first node is a first User Equipment (UE) or a NodeB,
wherein the first transmission is a sidelink transmission for a first cast type,
wherein the at least one second node includes a second UE,
wherein the second transmission is a sidelink transmission for a second cast type, and
wherein the first or second cast type is one of unicast, groupcast, or broadcast.

6. The method according to claim 1,
wherein the COT is occupied by a schedule request procedure (SR), a two-step random access (RA), or one or more sidelink transmissions using sidelink grants.

7. The method according to claim 6, wherein the COT is occupied after a successful listen before talk (LBT) operation.

8. The method according to claim 6, wherein the sidelink grant is one of dynamic sidelink grant, configured sidelink grant, or sidelink grant obtained by the first node itself from a resource pool.

9. The method according to claim 1, wherein the information regarding the COT is transmitted over the sidelink and/or the Uu link.

10. The method according to claim 9, wherein the information regarding the COT is transmitted from the NodeB to the second UE via at least one of a Downlink Control Information (DCI) based signaling, a medium access control (MAC) control element (CE) based signaling, a radio resource control (RRC) signaling, a control packet data unit (PDU) of a protocol layer based signaling.

11. The method according to claim 9, wherein the information regarding the COT is transmitted from the first UE to the second UE via at least one of a radio resource control (RRC) signaling on the sidelink, a medium access control (MAC) control element (CE) on the sidelink, a control packet data unit (PDU) of a protocol layer on the sidelink, a layer 1 (L1) signaling on the sidelink.

12. The method according to claim 1, wherein the gap between the first transmission and the second transmission is a value below 16 us or a value between 16 us and 25 us.

13. The method according to claim 1, wherein information for COT sharing between the first node and the at least one second node is obtained directly or indirectly from the information regarding the COT.

14. The method according to claim 1, wherein the information regarding the COT includes at least one of the time when the COT starts, the time when the COT ends, the time instants when a channel switch may occur, or the maximum number of channel switch events.

15. The method according to claim 14, wherein the information regarding the COT further includes at least one of:
the UE ID, or Destination L2 ID which has occupied the COT;
the gNB IDs or cell IDs which are allowed to use/share the COT;
the UE IDs that are allowed to share/use the COT;
the group IDs that are allowed to share/use the COT for groupcast case;
the Destination L2 IDs which are allowed to share/use the COT;
the SL transmission cast types which are allowed within the COT;
indicators on whether the COT can be shared with Uu transmissions;
the indices of services/logical channels/logical channel groups/channel access priority classes that are allowed to transmit within the COT;
what type control signaling/data is allowed to transmit within the COT; or
the category of LBT operations which is allowed for the at least second node to occupy the COT to be applied prior to its transmissions during the COT.

16. (canceled)

17. A method performed by a second node, comprising:
receiving information regarding a channel occupancy time (COT) from a first node, wherein the COT is occupied by the first node for initiating a first transmission over an unlicensed band; and
initiating a second transmission within the COT over the unlicensed band,
wherein at least one of the first transmission or the second transmission is a sidelink transmission.

18. The method according to claim 17, further comprising:
performing a listen before talk (LBT) operation according to the COT information prior to initiating the second transmission,
wherein the second transmission is initiated after the LBT operation is successful.

19. The method according to claim 17, further comprising:
performing a listen before talk (LBT) operation according to the gap between the end of the first transmission and the beginning of the second transmission prior to initiating the second transmission,
wherein the second transmission is initiated after the LBT operation is successful.

20-23. (canceled)

24. A first node, comprising:
at least one processor; and
a non-transitory computer readable medium coupled to the at least one processor, the non-transitory computer readable medium contains instructions executable by the at least one processor, whereby the at least one processor is configured to perform the method according to claim 1.

25. A second node, comprising:
at least one processor; and
a non-transitory computer readable medium coupled to the at least one processor, the non-transitory computer readable medium contains instructions executable by the at least one processor, whereby the at least one processor is configured to perform the method according to claim 17.

26-27. (canceled)
